(19) United States
(12) Patent Application Publication
(10) Pub. No.: US 2024/0298602 A1
(43) Pub. Date: Sep. 12, 2024

(54) MILKING SYSTEM

(71) Applicant: DELAVAL HOLDING AB, Tumba (SE)

(72) Inventor: Mats GUDMUNDSSON, Tumba (SE)

(21) Appl. No.: 18/567,226

(22) PCT Filed: Jun. 2, 2022
(86) PCT No.: PCT/SE2022/050537

§ 371 Date: Dec. 5, 2023

(30) Foreign Application Priority Data
Jun. 8, 2021 (SE) 2150722-3

(51) Int. Cl. A01J 5/04; A01J 5/007

(52) U.S. Cl. CPC A01J 5/048; A01J 5/007

(57) ABSTRACT

A milking system includes teat cups connected to a respective milk evacuation tube; a vacuum pump; a milk tank; vacuum adjustment arrangements, configured to adjust an inlet vacuum pressure level, provided to the respectively associated teat cup; vacuum pressure sensors each configured to measure vacuum pressure under each teat; a processing device configured to: set an inlet vacuum pressure level; obtain measurements of a resulting vacuum pressure level of the associated teat cup; compare it with a desired milking vacuum pressure level; calculate an adjusted inlet vacuum pressure level to achieve the desired milking vacuum pressure level; and cause adjustment according to the respectively calculated adjustment, independently of an animal identity.

### TECHNICAL FIELD

The invention refers to a milking system. More particularly, a milking system is described, comprising a plurality of teat cups, a plurality of milk evacuation tubes, a vacuum pump, a milk tank, a plurality of vacuum adjustment arrangements, a plurality of vacuum pressure sensors, and a processing device. The processing device is communicatively connected to the vacuum adjustment arrangements, and the vacuum pressure sensors. The processing device is configured to continuously adjust an inlet vacuum pressure level provided by the respective vacuum adjustment arrangement to the respective associated teat cup in order to achieve a desired milking vacuum pressure level at each teat cup during a milking session, independently of an identity of the animal.

### BACKGROUND

On a dairy farm, milk is typically extracted from animals by attaching a teat cup with a liner on each teat of the animal and apply a milking vacuum under the tip of the teat, in addition to a pulsation vacuum. Hereby, the rhythmical suckling of a calf is imitated so that sucking by the milking vacuum is interrupted by rhythmical motions, opening and closing of the liner caused by the pulsation vacuum. Consequently, the teats are exposed to massage which stimulates oxytocin release of the animal, which in turn activates the milk ejection reflex, resulting in milk release of alveoli milk about 40-60 seconds after attachment of the first teat cup onto the first teat. Also, congestion in the teat end is prevented by the applied massage.

It is desired to extract the milk from the animal as fast as possible for using the milking equipment efficiently and allowing a maximum number of animals to be milked, while avoiding injury on the teats due to excessive milking vacuum.

However, the milk flow of the teats of an animal is typically not equally distributed between the teats, for different reasons, e.g., genetic variations and/or that a teat may have a deviating size/shape making it less suitable for the applied teat cup/liner (the same teat cup/liner size is typically applied on all the teats independently of the actual teat size).

Not only the milk flow is unequally distributed, but also the increase rate of the milk flow during stimulation of the respective teat is different. Milk flow per time unit may be different for all teats of the animal during a milking session.

It has been observed that at least some animals do not release milk at a higher milk flow even when the milking vacuum is increased radically, why an increased applied milking vacuum of animal teats, for these animals, only lead to exposing the teats for the high milking vacuum, which may harm the teat.

These above-mentioned features may coincide and enforce each other, which exacerbates the problems.

It would be desired through further investigations and development to evolve a concept for improved milk evacuation in terms of time and efficiency while ensuring and/or enhancing a satisfying teat integrity.

### SUMMARY

It is therefore an object of this invention to solve at least some of the above problems and improve milking of an animal within a milking system.

According to a first aspect of the invention, this objective is achieved by a milking system. The milking system comprises a plurality of teat cups, each configured to fit on a respective teat of an animal during milk extraction in a milking session. The milking system also comprises a plurality of milk evacuation tubes, wherein each milk evacuation tube is connected to a respective teat cup. In addition, the milking system comprises a vacuum pump, configured to generate a system vacuum pressure, which may be referred to as system vacuum, at a system vacuum pressure level. In addition, the milking system also comprises a milk tank, connected to each of the teat cups via the respective connected milk evacuation tube, and also connected to the vacuum pump. In further addition, the milking system comprises a plurality of vacuum adjustment arrangements, each associated with one teat cup, and configured to adjust an inlet vacuum pressure level, provided to the respective teat cup. Also, the milking system in addition comprises a plurality of vacuum pressure sensors, each associated with one teat cup and configured to measure a vacuum pressure level prevailing in the associated teat cup under one of the teats during the milking session.

The milking system comprises a processing device. The processing device is communicatively connected to the vacuum adjustment arrangements, and the vacuum pressure sensors.

The processing device is configured to generate a respective command to each vacuum adjustment arrangement, to set the inlet vacuum pressure level to an inlet milking vacuum pressure level and provide the inlet vacuum pressure level to the associated teat cup in association with teat cup attachment. Also, the processing device is configured to obtain, repeatedly during the milking session, a measurement of the vacuum pressure level prevailing in the associated teat cup under one of the teats from the vacuum pressure sensor of the associated teat cup. In addition, the processing device is furthermore configured to compare, repeatedly during the milking session, the obtained respective measurement of the vacuum pressure level with a desired milking vacuum pressure level. The processing device is configured to calculate, repeatedly during the milking session, an adjustment of the inlet vacuum pressure level to be provided by each respective vacuum adjustment arrangements to the associated teat cup in order to achieve the desired milking vacuum pressure level in the associated teat cup, based on the made comparison.

The processing device is additionally configured to generate, repeatedly during the milking session, a respective command to each vacuum adjustment arrangement, to adjust the inlet vacuum pressure level according to the respectively calculated adjustment, thereby achieving the desired milking vacuum pressure level at each respective associated teat cup, as measured by the respective vacuum pressure sensor under each of the teats, independently of an identity of the animal.

By continuously measuring the respective vacuum pressure level in the teat cup under each animal teat, comparing it with the desired milking vacuum pressure level and, based on the made comparison, adjust the inlet vacuum pressure level provided by the vacuum adjustment arrangements, the respective vacuum pressure level in each teat cup is maintained at the desired milking vacuum pressure level, independently of any vacuum pressure leak between the vacuum adjustment arrangement and the respective teat cup; and/or any variation in milk flow of the respective teats. Thus, teat integrity is ensured, while a desired/high vacuum pressure level of the teat cups is achieved, also for teats having a high milk flow.

Thereby, by adapting the respective inlet vacuum pressure level to the change in vacuum pressure level under each of the teat cups, milk extraction is radically improved. The total milking time of each animal being served in a milking station/milking robot (in comparison with conventional solutions) is reduced which makes it possible to serve more animals per time unit at the milking system. Yet, milking is performed in a gentle manner, eliminating, or at least reducing inconvenience of the animal caused by excessive vacuum pressure acting on the teats. Excessive vacuum pressure may cause injuries which in turn may encourage udder diseases such as mastitis, which may have severe economical consequences of the farm, besides the suffering of the individual animal.

In an implementation of the milking system according to the first aspect, the processing device is configured to generate, repeatedly during the milking session, the command to adjust the inlet vacuum pressure level in order to maintain the desired milking vacuum pressure level substantially constant at each respective associated teat cup, as measured by the respective vacuum pressure sensor under each of the teats during at least a majority time of the milking session.

In another implementation of the milking system according to the first aspect, the processing device is configured to estimate a difference between a highest measurement and a lowest measurement, respectively, of the vacuum pressure level in one of the teat cups as measured by the respective vacuum pressure sensor during a time period. The processing device is also configured to, in case the estimated difference is smaller than a threshold limit, set, temporarily, the desired milking vacuum pressure level to a high flow milking vacuum pressure level for the teat cup.

When the vacuum pressure level in the teat cup is fairly constant over the time period (i.e., below the threshold limit), as measured by the vacuum pressure sensor at least at two different moments in time within the time period, this is interpreted as the milk flow of the teat of the animal has reached a plateau phase at or around a maximum milk flow peak. Thus, the desired vacuum pressure level of the teat cup could be increased to the high flow milking vacuum pressure level, without risk of exposing the animal teat for an excess vacuum pressure.

Advantages of increasing the vacuum pressure level in the teat cup when the milk flow of the teat is very high/around a maximum milk flow level, is that the milking session could be terminated earlier than according to previously known solutions or when maintained constant, why more animals could be served per time unit by the same milking equipment. The farmer could recruit more animals to the farm without having to invest in new milking equipment, thereby increasing the total milk yield at the farm.

In an implementation of the milking system according to the first aspect, the processing device is configured to repeatedly during the milking session, generate a respective command to the vacuum adjustment arrangement associated with each teat cup attached to the respective teat, to either increase or decrease the inlet vacuum pressure level to be provided to the teat cup.

The vacuum adjustment arrangement is thus configured to either: increase the inlet vacuum pressure level to be provided to the teat cup with the adjustment when the latest obtained vacuum pressure level in the teat cup under the teat, obtained from the vacuum pressure sensor is lower than the desired milking vacuum pressure level in the teat cup under the teat; or decrease the inlet vacuum pressure level to be provided to the teat cup with the adjustment when the latest obtained vacuum pressure level in the teat cup under the teat, obtained from the vacuum pressure sensor exceeds the desired milking vacuum pressure level in the teat cup under the teat.

By being able to measure the vacuum pressure level of each teat cup frequently, a better control of the current/instantaneous vacuum pressure is achieved. An adaptation of the applied inlet vacuum pressure level may then be made continuously via the vacuum adjustment arrangements associated with the teat cup. It thereby becomes possible to provide each teat cup with an appropriate inlet vacuum pressure level, causing the desired vacuum level in the teat cup, for time-efficient milking while avoiding vacuum caused damages or irritation of the teats.

In yet an implementation of the milking system according to the first implementation of the first aspect, the size of the adjustment may be proportional to a difference between the latest obtained vacuum pressure level and the previously obtained vacuum pressure level, as measured by and obtained from the respective vacuum pressure sensor.

By instructing the vacuum adjustment arrangements to change the inlet vacuum pressure level in a step size which may be proportional to a detected difference between the measurements, it is avoided that an inappropriate vacuum pressure level is applied to the teat cup, by maintaining a substantially constant vacuum pressure level in the teat cup under each respective teat.

In another implementation of the milking system according to the first aspect, or any implementation thereof, the processing device is configured to: generate a respective command to at least one vacuum adjustment arrangement, to decrease the inlet vacuum pressure level at the corresponding teat cup when the milking session is estimated to approach ending.

By reducing the inlet vacuum pressure level towards the end of the milking session, the vacuum pressure level in the teat cup under the teats is reduced, which facilitates teat cup take-off.

In another implementation of the milking system according to the first aspect, or any implementation thereof, the vacuum adjustment arrangements comprise a respective vacuum regulator and a valve device.

In another implementation of the milking system according to the first aspect, or any implementation thereof, the vacuum adjustment arrangements comprise an operable valve having a passage, wherein the valve is arranged in the milk evacuation tube and the milk extracted during the milk session passes the passage.

Hereby an embodiment of the vacuum adjustment arrangement is specified, wherein the operable valve may be adjusted by a solenoid, based on electric control signals.

In another implementation of the milking system according to the first aspect, or any implementation thereof, the processing device is configured to detect that the teat cups are to be attached on to the teats of the animal. Also, the processing device is configured to generate a respective command to each vacuum adjustment arrangement, to set the inlet vacuum pressure level to an inlet attachment vacuum pressure level and provide the inlet vacuum pressure level to the associated teat cup in association with teat cup attachment, wherein the inlet attachment vacuum pressure level represents less under-pressure than the inlet milking vacuum pressure level.

By providing a dedicated inlet attachment vacuum pressure when the teat cups are to be attached, which is lower (i.e., involving less under-pressure) than the milking vacuum pressure level, attachment of the teat cups is facilitated.

In another an implementation of the milking system according to the first aspect, or any implementation thereof, a maximum allowed vacuum pressure level allowed to prevail in any of the teat cups under any of the teats, as measured by the vacuum pressure sensor is within an interval of 35-55 kPa, preferably 44-49 kPa.

It is hereby avoided that any teat is exposed for an excessive vacuum pressure in case the milk flow of the teat is not corresponding to the applied vacuum pressure. Thereby a gentle treatment of the teats of the animal is ascertained yet enabling application of an efficient vacuum pressure adapted to the teat capacity which ameliorates and streamline the milking session, as the milk thereby is extracted in short time while not abusing teat integrity of the animal.

In yet another an implementation of the milking system according to the first aspect, or any implementation thereof, the vacuum pressure sensor is configured to measure the vacuum pressure level prevailing at each teat cup under the respective teat with substantially 10-1000 measurements per second, preferably 100-1000 measurements per second.

The more frequently the vacuum pressure level in the teat cup is measured, the more precise fine-tuning of the applied vacuum pressure level could be made for achieving the desired vacuum pressure level also when there are deviations in the milk flow of the animal in comparison with earlier milking sessions and/or between different teats and/or animals.

In yet an implementation of the milking system according to the first aspect, or any implementation thereof, the processing device is configured to calculate a rolling average of vacuum pressure levels prevailing at each teat cup under the respective teat, based on a predetermined number of latest vacuum pressure levels obtained from the respectively associated vacuum pressure sensor. In addition, the comparison with the desired milking vacuum pressure level is made with the calculated rolling average of vacuum pressure levels.

The calculated rolling average of for example the latest 5 or 10 measured vacuum pressure levels evens out arbitrary fluctuations in the measurements, resulting in a more reliable and stable comparison with the desired vacuum pressure level.

In yet an implementation of the milking system according to the first aspect, or any implementation thereof, the system vacuum pressure generated by the vacuum pump, prevailing in the milk tank is maintained substantially constant during the majority time of the milking session.

Hereby, a time efficient, yet teat friendly milk extraction is provided.

Other advantages and additional novel features will become apparent from the subsequent detailed description.

### FIGURES

Embodiments of the invention will now be described in further detail with reference to the accompanying figures, in which:

FIG. 1 illustrates a milking system according to an embodiment.

FIG. 2 illustrates a milking system according to an embodiment.

FIG. 3A is a conceptual illustration depicting principles of a milking system according to an embodiment.

FIG. 3B is a conceptual illustration depicting principles of a milking system according to an embodiment.

FIG. 4A is a diagram that illustrates an example of milk flow rate and vacuum pressure level during milk extraction in a milking session.

FIG. 4B is a diagram that illustrates an example of milk flow rate and vacuum pressure level during milk extraction in a milking session.

FIG. 5 is a combined flow chart and signalling scheme, conceptually illustrating vacuum pressure adjustment, according to an embodiment.

### DETAILED DESCRIPTION

Embodiments of the invention described herein are defined as a milking system, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

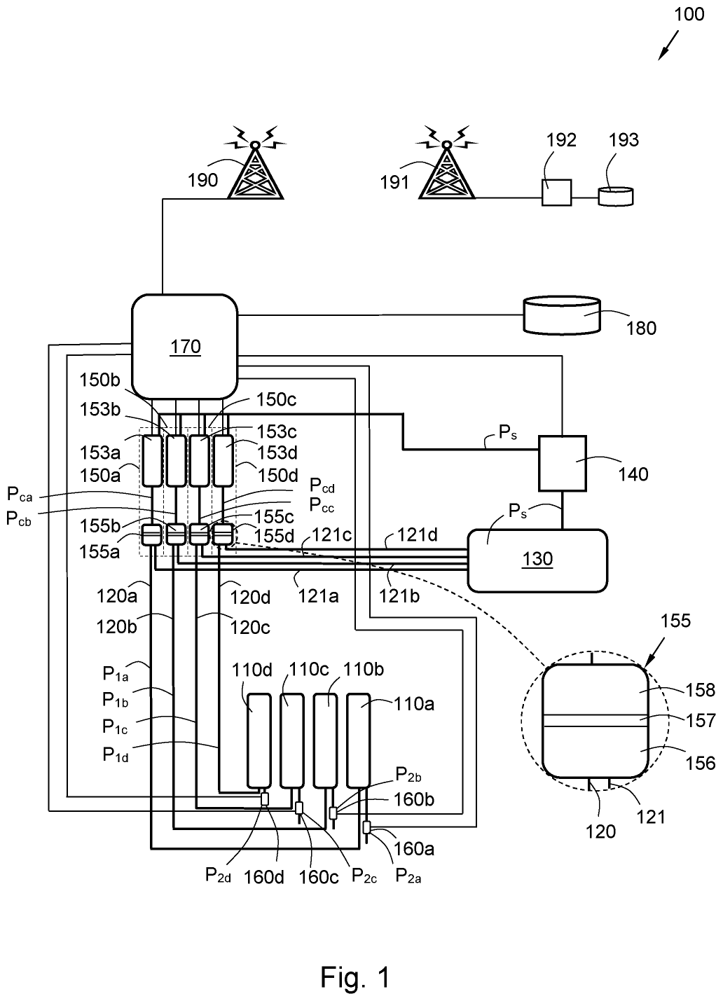

FIG. 1 illustrates a milking system 100 configured to extract milk from an animal during a milking session. The animal may be comprised in a herd of animals for dairy farming at a farm. The milking system 100 may with advantage, although not necessarily, be implemented in an automatic milking facility, for example a milking robot, which may be arranged e.g., for voluntary milking of freely strolling animals, wherein the animals may visit the milking facility/milking system 100 in order to be milked when desired.

“Animal” may be any arbitrary type of domesticated female mammal such as e.g. cow, goat, sheep, camel, horse, dairy buffalo, donkey, yak, etc. (non-exhaustive list of animals). The animal may have four teats, as for example cows, or two teats, such as for example goats and/or sheep. Other animals may have other numbers of teats.

The milking system 100 comprises a plurality of teat cups 110a, 110b, 110c, 110d. The number of teat cups 110a, 110b, 110c, 110d is typically identical with the number of teats of the animal to be milked within the milking system 100. Each teat cup 110a, 110b, 110c, 110d is configured to fit on a respective teat of the animal and to be attached thereto during milk extraction in the milking session.

Each teat cup 110a, 110b, 110c, 110d is connected to a respective milk evacuation tube 120a, 120b, 120c, 120d, leading extracted milk from the respective teat, via a second part of the milk evacuation tube 121a, 121b, 121c, 121d, to a connected milk tank 130. The milk tank 130 is in turn connected to a vacuum pump 140 that has generated and/or continuously generates a system vacuum pressure Pₛ supplied to the milk tank 130. The system vacuum pressure Pₛ may be for example somewhere between about 48-55 kPa (arbitrary, non-limiting examples). The system vacuum pressure Pₛ may be maintained substantially constant over time in the milk tank 130 during the majority time of the milking session.

The expressions “vacuum pressure” and/or “milking vacuum” and/or “system vacuum pressure” respectively, refers to under-pressure/lower pressure in comparison with the environmental atmospheric pressure. A vacuum pressure level of 10 kPa thus means a vacuum pressure level which is 10 kPa lower than the environmental atmospheric pressure.

The milk tank 130 may collect milk extracted during the milking session, which may be forwarded via a pump arrangement and a tubing, to a connected cooling tank where the milk may be collected and maintained at chilled temperature until being emptied when the milk truck arrives to the farm.

The milking system 100 also comprises a plurality of vacuum adjustment arrangements 150a, 150b, 150c, 150d, each one associated with adjustment of an inlet vacuum pressure level P₁ₐ, P_{1b}, P_{1c}, P_{1d} provided to a respective teat cup 110a, 110b, 110c, 110d.

The vacuum pump 140 and/or the milk tank 130 may be connected to each vacuum adjustment arrangement 150a, 150b, 150c, 150d, thereby providing system vacuum Pₛ to the vacuum adjustment arrangements 150a, 150b, 150c, 150d. By regulating a milk passage of a valve in a controlled manner, the vacuum adjustment arrangement 150a, 150b, 150c, 150d may adjust the system vacuum level Pₛ into the inlet vacuum pressure level P₁ₐ, P_{1b}, P_{1c}, P_{1d} provided to the respective teat cup 110a, 110b, 110c, 110d.

The vacuum adjustment arrangements 150a, 150b, 150c, 150d may comprise a vacuum regulator 153a, 153b, 153c, 153d operating in conjunction with a respective valve device 155a, 155b, 155c, 155d, in some embodiments, as schematically illustrated in FIG. 1.

Each vacuum regulator 153a, 153b, 153c, 153d of the vacuum adjustment arrangements 150a, 150b, 150c, 150d may comprise a solenoid wherein position of a valve of the solenoid may be adjusted by adjusting a magnetic field surrounding the solenoid for example with a Pulse Width Modulation (PWM) signal generated by a processing device 170 communicatively connected to the vacuum regulator 153a, 153b, 153c, 153d, thereby changing a mixture of system vacuum Pₛ of the vacuum pump 140 and air of atmospheric pressure for generating a control vacuum, in some embodiments.

The vacuum regulator 153a, 153b, 153c, 153d may comprise or be connected to a respective valve device 155a, 155b, 155c, 155d. The valve devices 155a, 155b, 155c, 155d may be arranged in, or associated with, the respective milk evacuation tube 120a, 120b, 120c, 120d of the respective teat cup 110a, 110b, 110c, 110d.

The valve device 155a, 155b, 155c, 155d, according to some embodiments, comprises a wet section 156 and a dry section 158, separated by a membrane 157. The first milk evacuation tube section 120a, 120b, 120c, 120d, and the second milk evacuation tube section 121a, 121b, 121c, 121d are passing the wet section 156 of the valve device 155a, 155b, 155c, 155d.

The vacuum pressure level prevailing in the teat cup 110a, 110b, 110c, 110d associated with the milk evacuation tube 120a, 120b, 120c, 120d, upstreams the valve device 155a, 155b, 155c, 155d may be adjusted to the same vacuum level as a control vacuum level P_{ca}, P_{cb}, P_{cc}, P_{cd} provided to the dry section 158 of the valve device 155a, 155b, 155c, 155d by the vacuum regulator 153a, 153b, 153c, 153d, in some embodiments. The control vacuum level P_{ca}, P_{cb}, P_{cc}, P_{cd} may sometimes also be referred to as pilot vacuum level.

Thus, the vacuum pressure level prevailing in the teat cup 110a, 110b, 110c, 110d under the teat may be adjusted individually in order to achieve a target/desired vacuum pressure level.

The valve device 155a, 155b, 155c, 155d may for example comprise a per se known shut off valve in some embodiments.

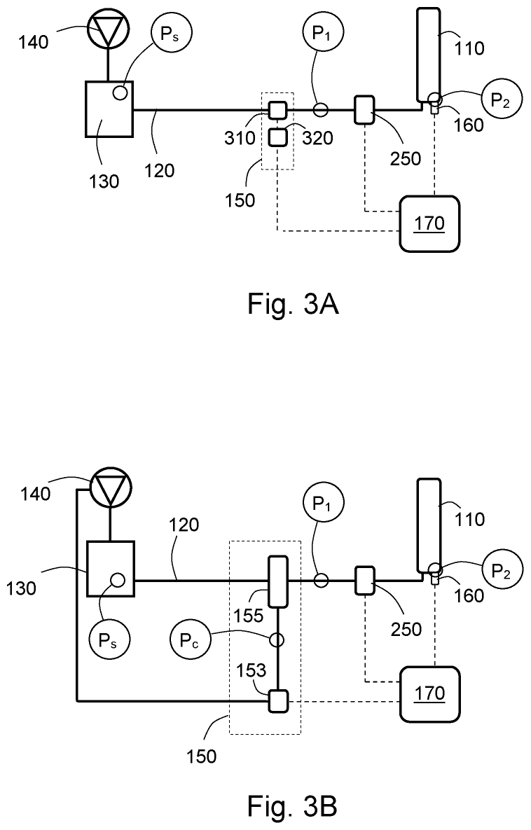

The vacuum adjustment arrangements 150a, 150b, 150c, 150d may in some alternative embodiments comprise an operable valve having a passage which is adjustable by an electric control signal provided by the processing device 170, as schematically illustrated in FIG. 3A and discussed in the corresponding section of the description.

The vacuum adjustment arrangements 150a, 150b, 150c, 150d may in some other alternative embodiments comprise an operable valve which is mechanically adjustable for example by an actuator operating in conjunction with a spring or other similar resilient device enabling storage of potential energy.

In addition, the milking system 100 comprises a plurality of vacuum pressure sensors 160a, 160b, 160c, 160d. Each vacuum pressure sensor 160a, 160b, 160c, 160d is associated with one teat cup 110a, 110b, 110c, 110d and is configured to measure vacuum pressure level P₂ₐ, P_{2b}, P_{2c}, P_{2d} prevailing in the associated teat cup 110a, 110b, 110c, 110d under one of the teats during milk extraction of the milking session. Thus, one vacuum pressure sensor 160a, 160b, 160c, 160d may be dedicated to measuring vacuum pressure level P₂ₐ, P_{2b}, P_{2c}, P_{2d} prevailing in one specific teat cup 110a, 110b, 110c, 110d under one of the teats.

The milking system 100 furthermore may comprise a database 180 in some embodiments, configured to store data, for example related to various vacuum pressure levels, such as an inlet milking vacuum pressure level Pᵢₘ, a desired milking vacuum pressure level Pₘ, an inlet attachment vacuum pressure level Pᵢₐ, a detachment vacuum pressure level P_{d}, a maximum allowed vacuum pressure level Pₘₐₓ, and other similar data.

The milking session may be regarded as beginning when a pre-treatment is performed on the first teat of the animal, which starts stimulation of oxytocin release of the animal. The pre-treatment may comprise cleaning of the teat, by rinsing the teat with water, treating the teat with a brush or otherwise teasing/stimulating the teat. The required time-period from the start of the pre-treatment to release of alveoli milk may be about 40-60 seconds; however, this time may be different for different breeds, different individual animals and also for the same animal in different situations and may be regarded as merely a rough estimation.

However, pre-treatment may not be performed at all farms. In case pre-treatment is not performed, the milking session may be considered to begin when the first teat cup 110a, 110b, 110c, 110d is attached to the first teat.

In addition, the milking system 100 also comprises a processing device 170 which is communicatively connected to the vacuum adjustment arrangements 150a, 150b, 150c, 150d, the vacuum pressure sensors 160a, 160b, 160c, 160d, and possibly also the optional database 180, 193, for instance via a wireless connection based on radio or optical technique, or a wired connection implemented by electric cable or optic fibre.

The target issue of the processing device 170 is to achieve a desired milking vacuum pressure level Pₘ under each of the teats. The desired milking vacuum pressure level Pₘ may then be maintained substantially constant during at least a part of the milking session, in some embodiments.

The vacuum pressure sensor 160a, 160b, 160c, 160d may be configured to measure vacuum pressure level P₂ₐ, P_{2b}, P_{2c}, P_{2d} in the respective teat cup 110a, 110b, 110c, 110d under the teat, with substantially 10-1000 measurements per second, preferably 100-1000 measurements per second, in some embodiments.

The vacuum pressure sensor 160a, 160b, 160c, 160d may also be configured to measure the vacuum pressure level P₂ₐ, P_{2b}, P_{2c}, P_{2d} in the respective teat cup 110a, 110b, 110c, 110d under the teat, at least two times during a time period when a liner of the respective teat cup 110a, 110b, 110c, 110d is open, in yet some embodiments.

The processing device 170 is configured to generate a respective command to each vacuum adjustment arrangement 150a, 150b, 150c, 150d, to set the inlet vacuum pressure level P₁ₐ, P_{1b}, P_{1c}, P_{1d} to an inlet milking vacuum pressure level Pᵢₘ and provide the inlet vacuum pressure level P₁ₐ, P_{1b}, P_{1c}, P_{1d} to the associated teat cup 110a, 110b, 110c, 110d, in association with teat cup attachment.

Also, the processing device 170 is configured to obtain, repeatedly during the milking session, a measurement of the vacuum pressure level P₂ₐ, P_{2b}, P_{2c}, P_{2d} prevailing in the associated teat cup 110a, 110b, 110c, 110d under one of the teats from the vacuum pressure sensor 160a, 160b, 160c, 160d of the associated teat cup 110a, 110b, 110c, 110d.

The processing device 170 is also configured to compare, repeatedly during the milking session, the obtained respective measurement of the vacuum pressure level P₂ₐ, P_{2b}, P_{2c}, P_{2d} with a desired milking vacuum pressure level Pₘ. The desired milking vacuum pressure level Pₘ may be for example within 35-55 kPa, in some embodiments; preferably 44-49 kPa. The desired milking vacuum pressure level Pₘ may be predetermined and applied for all teats on all animals at the farm and may be kept substantially constant during at least a part of the milking session.

The maximum allowed vacuum pressure level Pₘₐₓ allowed by the processing device 170 to prevail in any of the teat cups 110a, 110b, 110c, 110d under any of the teats, as measured by the vacuum pressure sensor 160a, 160b, 160c, 160d is within an interval of 35-55 kPa, at least in some legislations, when the animal is a cow. When the animal is a sheep or a goat, the maximum allowed vacuum pressure level may be set within the range of 28-38 kPa, etc.

The inlet milking vacuum pressure level Pᵢₘ and/or the desired milking vacuum pressure level Pₘ and/or the maximum allowed vacuum pressure level Pₘₐₓ may be stored in and/or retrieved by the processing device 170 from the database 180, in some embodiments.

In addition, the processing device 170 is configured to calculate, repeatedly during the milking session, an adjustment ΔP of the inlet vacuum pressure level P₁ₐ, P_{1b}, P_{1c}, P_{1d} to be provided by each respective vacuum adjustment arrangements 150a, 150b, 150c, 150d to the associated teat cup 110a, 110b, 110c, 110d in order to achieve the desired milking vacuum pressure level Pₘ in the associated teat cup 110a, 110b, 110c, 110d, based on the made comparison between the vacuum pressure level P₂ₐ, P_{2b}, P_{2c}, P_{2d} prevailing in the associated teat cup 110a, 110b, 110c, 110d and the desired milking vacuum pressure level Pₘ.

The processing device 170 is furthermore configured to generate, repeatedly during the milking session, a respective command to each vacuum adjustment arrangement 150a, 150b, 150c, 150d, to adjust the inlet vacuum pressure level P₁ₐ, P_{1b}, P_{1c}, P_{1d} according to the respectively calculated adjustment ΔP, thereby achieving the desired milking vacuum pressure level Pₘ at each respective associated teat cup 110a, 110b, 110c, 110d, as measured by the respective vacuum pressure sensor 160a, 160b, 160c, 160d under each of the teats during at least a part of the milking session for example during the majority time of the milking session, independently of an identity of the animal, i.e., without knowing the identity of the animal.

Thus, the same desired milking vacuum pressure level Pₘ may be targeted for all teats of all animals of the same kind at the farm. A direct, real time (or almost real time) control of the vacuum pressure level P₂ₐ, P_{2b}, P_{2c}, P_{2d} under each respective teat is enabled.

The processing device 170 may then obtain the current/instantaneous (or almost current/instantaneous with some insignificant time delay) measurements of the vacuum pressure level P₂ₐ, P_{2b}, P_{2c}, P_{2d} prevailing in the associated teat cup 110a, 110b, 110c, 110d under one of the teats as measured by the associated vacuum pressure sensor 160a, 160b, 160c, 160d.

Based on the outcome of the comparison with the desired milking vacuum pressure level Pₘ, the processing device 170 may generate a command to the vacuum adjustment arrangements 150a, 150b, 150c, 150d associated with the teat cup 110a, 110b, 110c, 110d and the teat, to adjust the inlet vacuum pressure level P₁ₐ, P_{1b}, P_{1c}, P_{1d} in order to keep the vacuum pressure level P₂ₐ, P_{2b}, P_{2c}, P_{2d} under the teat at the desired milking vacuum pressure level Pₘ.

It is desired to extract the milk of the animal efficiently, during as short time as possible (to allow for more animals per time unit to be served by the milking system 100), without harming or hurting the teats by applying an excessive vacuum level under the teat.

Thanks to the disclosed concept, a methodology has been developed towards a teat specific adaptation of the inlet vacuum pressure level P₁ₐ, P_{1b}, P_{1c}, P_{1d} provided to the teat cup 110a, 110b, 110c, 110d, promoting efficient milking, yet conserving teat integrity.

Thus, the milk extraction can be made more efficient than according to previously known methods.

In some embodiments, the control algorithm of the processing device 170 may comprise, be based on, or inspired by a Proportional-Integral-Derivative (PID) regulator with a feed forward model.

The control function of the vacuum pressure level P₂ₐ, P_{2b}, P_{2c}, P_{2d} in each of the teat cups 110a, 110b, 110c, 110d could thereby be made by repeatedly applying an accurate and responsive correction to the inlet vacuum pressure level P₁ₐ, P_{1b}, P_{1c}, P_{1d}.

The control loop may run at about 1 Hz in some embodiments. Hereby, a frequent update of the inlet vacuum pressure level P₁ₐ, P_{1b}, P_{1c}, P_{1d} provided by the vacuum adjustment arrangements 150a, 150b, 150c, 150d is achieved, leading to a stable vacuum pressure level P₂ₐ, P_{2b}, P_{2c}, P_{2d} in the teat cups 110a, 110b, 110c, 110d, which is identical with or close to the desired milking vacuum pressure level Pₘ.

The processing device 170 may be configured to, repeatedly during the milking session, generate a respective command to the vacuum adjustment arrangement 150a, 150b, 150c, 150d associated with each teat cup 110a, 110b, 110c, 110d attached to the respective teat, to increase the inlet vacuum pressure level P₁ₐ, P_{1b}, P_{1c}, P_{1d} to be provided to the teat cup 110a, 110b, 110c, 110d with the adjustment ΔP when the latest obtained vacuum pressure level P₂ₐ, P_{2b}, P_{2c}, P_{2d} under the teat, obtained from the vacuum pressure sensor 160a, 160b, 160c, 160d is lower than the desired milking vacuum pressure level Pₘ under the teat.

Also, alternatively, the processing device 170 may be configured to decrease the inlet vacuum pressure level P₁ₐ, P_{1b}, P_{1c}, P_{1d} to be provided to the teat cup 110a, 110b, 110c, 110d with the adjustment ΔP when the latest obtained vacuum pressure level P₂ₐ, P_{2b}, P_{2c}, P_{2d} under the teat, obtained from the vacuum pressure sensor 160a, 160b, 160c, 160d exceeds the desired milking vacuum pressure level Pₘ under the teat.

The processing device 170 may in some embodiments be configured to adjust, i.e. increase or decrease the inlet vacuum pressure level P₁ₐ, P_{1b}, P_{1c}, P_{1d} to be provided to the teat cup 110a, 110b, 110c, 110d with a size of the adjustment ΔP is proportional to a difference between the latest obtained vacuum pressure level P₂ₐ, P_{2b}, P_{2c}, P_{2d} and the previously obtained vacuum pressure level P₂ₐ, P_{2b}, P_{2c}, P_{2d}, as measured by and obtained from the respective vacuum pressure sensor 160a, 160b, 160c, 160d.

The adjustment of the vacuum pressure level P₂ₐ, P_{2b}, P_{2c}, P_{2d} under the teat may thereby be made with regard to the size of the deviation between the vacuum pressure levels obtained at different moments in time in some embodiments, leading to a better correspondence between the applied inserted vacuum pressure level at the teat and the milk flow of the teat, as a future trend of the deviation between the measured vacuum pressure level P₂ₐ, P_{2b}, P_{2c}, P_{2d} and the desired milking vacuum pressure level Pₘ is estimated, based on its current rate of change. The adjustment ΔP of the inlet vacuum pressure level P₁ₐ, P_{1b}, P_{1c}, P_{1d} may thereby be anticipated by exerting a control influence generated by the rate of deviation change as measured in the teat cup 110a, 110b, 110c, 110d, improving the control.

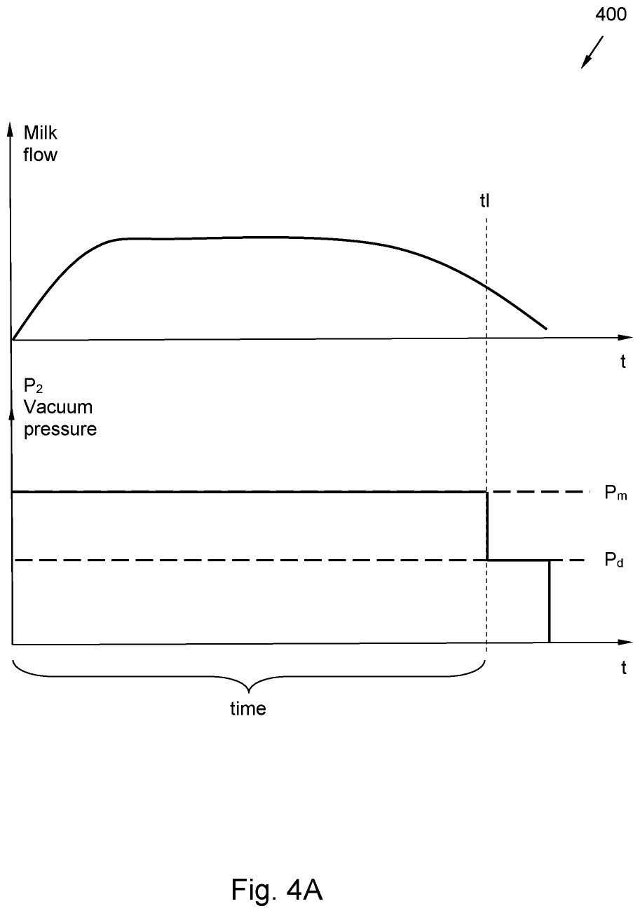

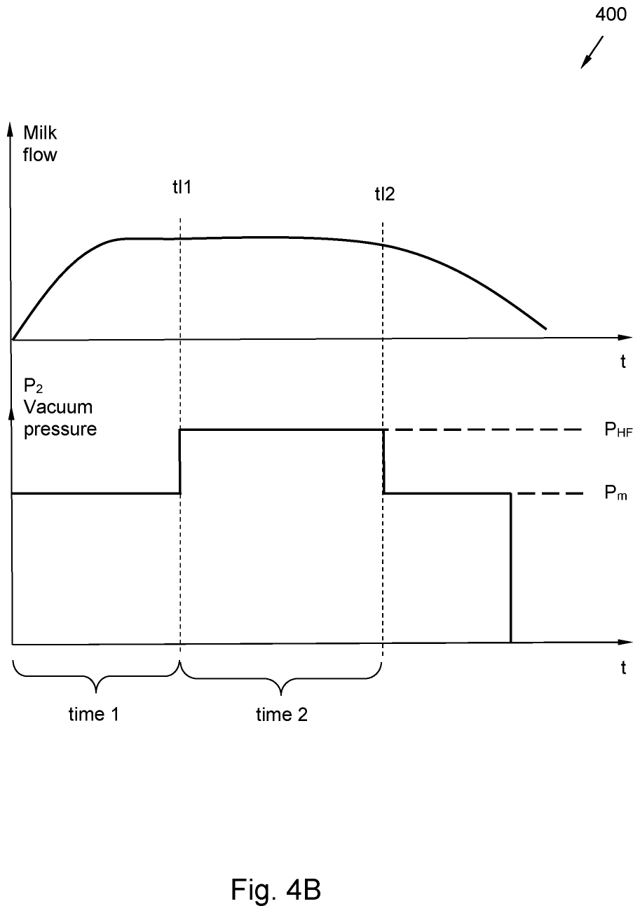

The processing device 170 may be configured to generate a respective command to at least one vacuum adjustment arrangement 150a, 150b, 150c, 150d, to decrease the inlet vacuum pressure level P₁ₐ, P_{1b}, P_{1c}, P_{1d} at the corresponding teat cup 110a, 110b, 110c, 110d when the milking session is estimated to approach ending. This process is schematically illustrated in FIG. 4A.

When the milking session is about to end, a detachment vacuum pressure P_{d} may be applied to enable smooth teat cup take-off, in some embodiments. The detachment vacuum pressure level P_{d} may be set to approximately 10-20 kPa, such as for example about 15 kPa.

The detachment of the teat cups 110a, 110b, 110c, 110d is thereby simplified, leading to a smooth and gentle performance of the milking session.

In some embodiments, the processing device 170 may be configured to detect that the teat cups 110a, 110b, 110c, 110d are to be attached on to the teats of the animal.

In addition, the processing device 170 may be configured to generate a respective command to each vacuum adjustment arrangement 150a, 150b, 150c, 150d, to set the inlet vacuum pressure level P₁ₐ, P_{1b}, P_{1c}, P_{1d} to an inlet attachment vacuum pressure level Pᵢₐ, also referred to as soft start, and provide the inlet vacuum pressure level P₁ₐ, P_{1b}, P_{1c}, P_{1d} to the associated teat cup 110a, 110b, 110c, 110d in association with teat cup attachment, wherein the inlet attachment vacuum pressure level Pᵢₐ represents less under-pressure than the inlet milking vacuum pressure level Pᵢₘ.

The inlet attachment vacuum pressure level Pᵢₐ may be for example 20-35 kPa (arbitrary non-limiting example).

In yet some embodiments, the processing device 170 may be configured to calculate a rolling average of vacuum pressure levels P₂ₐ, P_{2b}, P_{2c}, P_{2d} prevailing at each teat cup 110a, 110b, 110c, 110d under the respective teat, based on a predetermined number of latest vacuum pressure levels P₂ₐ, P_{2b}, P_{2c}, P_{2d} obtained from the respectively associated vacuum pressure sensor 160a, 160b, 160c, 160d. Hereby, deviations in measurement results due to arbitrary fluctuations in measurement results is evened out, leading to more reliable measurements of vacuum pressure levels P₂ₐ, P_{2b}, P_{2c}, P_{2d} under the teat.

The processing device 170 may also be configured to compare the desired milking vacuum pressure level Pₘ with the calculated rolling average of vacuum pressure levels. Thereby minor fluctuations in measurements are evened out, leading to more stable vacuum pressure adjustments.

The milking system 100 may also in some embodiments comprise a communication device 190 for communication with a central processing device 192 of a service provider. The central processing device 192 may in turn be connected to a central database 193 wherein various related data may be stored, such as e.g., limitations due to SS-ISO 5707:2007 or other similar standard; maximum allowed vacuum pressure level Pₘₐₓ, the desired milking vacuum pressure level Pₘ, inlet milking vacuum pressure level Pᵢₘ, etc.

The processing device 170 at the farm may be configured to achieve various data from the central database 193 such as specified above; or download software updates, for example.

In some embodiments, the processing device 170 may be configured to upload for example vacuum pressure measurement data of animals at the farm, detections of deviating vacuum pressure levels (which may indicate air leakage in the system), etc.

The processing device 170 may with general advantage be configured to perform the above-described procedure in an automatic manner by executing a computer program. Therefore, according to some embodiment, the processing device 170 may comprise a memory unit, i.e., non-volatile data carrier, storing the computer program, which, in turn, may contain software for making a processing circuitry in the form of at least one processor in the processing device 170 to execute the above-described actions when the computer program is run on the processing circuitry.

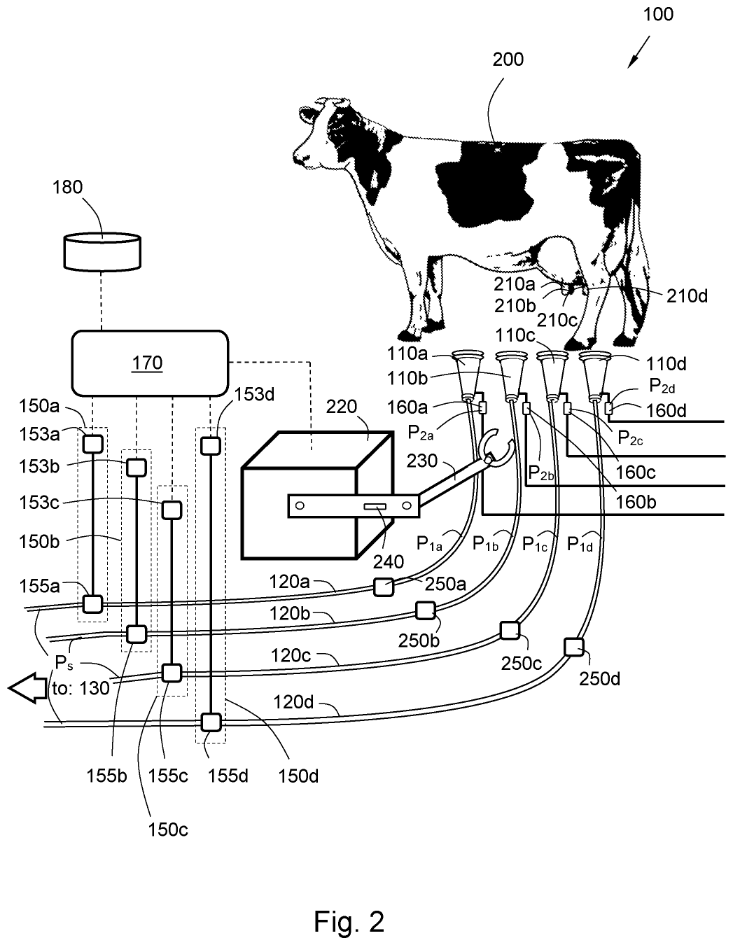

FIG. 2 illustrates a milking system 100 comprising a teat cup placing device 220 such as a milking robot comprising a robotic arm 230, communicatively connected to a sensor 240, such as a camera, video camera, lidar, radar, infrared camera, etc. The sensor 240 is configured to detect position of each teat 210a, 210b, 210c, 210d of an animal 200 to be milked.

In the illustrated non-limiting embodiment, teat cup placing device 220 is embodied as a milking robot, which may be part of an Automatic Milking System (AMS), sometimes also referred to as a Voluntary Milking System (VMS), or similar system. The herein disclosed methodology and milking system 100 is not limited to usage involving a milking robot but may be utilised together with any commonly known milking concept such as tied-up animals in a milking parlour and/or manual milking in a milking pit or a rotary milking parlour.

A pulsating pressure may be applied when the teat cups 110a, 110b, 110c, 110d have been attached on the animal teats 210a, 210b, 210c, 210d. The pulsating pressure levels applied to a pulsation chamber via a pulse tube in the teat cup 110a, 110b, 110c, 110d may in some embodiments vary between atmospheric pressure during the rest phase D, and vacuum pressure during the milking phase B in some embodiments. The arrangements for applying pulsating vacuum are not illustrated in the drawings.

Thus, sucking is interrupted by rhythmical repeated motions, opening and closing, of a liner in the teat cup 110a, 110b, 110c, 110d. The force exerted by the collapsed liner causes a massage to the teat. Consequently, the teats 210a, 210b, 210c, 210d are exposed to massage and congestion (e.g., of blood) in the teat end is prevented while oxytocin release and milk ejection is stimulated by the rhythmical movements of the collapsing and opening liner in combination with the applied milking vacuum, mimicking calf suckling.

The teat cup placing device 220 may be communicatively connected to the sensor 240, via a wired or wireless connection, thereby obtaining information concerning the respective position of the animal teat 210a, 210b, 210c, 210d. The teat cup placing device 220 may be configured to sequentially attach each of the teat cups 110a, 110b, 110c, 110d onto the respective teat 210a, 210b, 210c, 210d of the animal 200, based on sensor detections made by the sensor 240. The teat cups 110a, 110b, 110c, 110d may be kept in a storage magazine or similar storage zone, where the teat cup placing device 220 may pick it up one at the time and attach it onto one of the teats 210a, 210b, 210c, 210d and repeat this until all teat cups 110a, 110b, 110c, 110d have been attached.

The data concerning the inlet milking vacuum pressure level Pᵢₘ, desired milking vacuum pressure level Pₘ, inlet attachment vacuum pressure level Pᵢₐ, and/or maximum allowed vacuum pressure level Pₘₐₓ, etc., may be stored in, for example a digital memory or database 180, communicatively connected to, or comprised in the processing device 170, and later retrieved there from. Alternatively, or in addition, the data may be stored in a central database 193, where it may be accessed by a central processing device 192.

The processing device 170 may operate in conjunction with the teat cup placing device 220, to control the robotic arm 230 to start attaching the teat cups 110a, 110b, 110c, 110d on the respective teat 210a, 210b, 210c, 210d, one-by-one or possibly in clusters.

The processing device 170 may be communicationally connected to the database 180, 193, and/or optionally also to a number of milk meters 250a, 250b, 250c, 250d. The milk meters 250a, 250b, 250c, 250d may be configured to measure the milk flow per time unit, e.g., milk flow rate of each milk evacuation tube 120a, 120b, 120c, 120d and/or teat cup 110a, 110b, 110c, 110d; and/or the total amount of extracted milk of the animal 200 during the milking session.

It may be noted that the milk meters 250a, 250b, 250c, 250d could be omitted when the provided solution is implemented; i.e., that the provided solution could be implemented without requiring milk meters 250a, 250b, 250c, 250d at the farm. An advantage is thus that milk could be extracted efficiently, yet without requiring or being dependent upon milk meters 250a, 250b, 250c, 250d; or stored individual data of animals at the farm, which saves resources.

The amount of milk extracted from the animal 200 during the milking session may be estimated based on measurements before and after the milking session of the difference in stored volume of milk in the milk tank 130, for example by applying and studying movements of a float in the milk tank 130, in some embodiments.

In some embodiments, the processing device 170 may establish and maintain the desired milking vacuum pressure level Pₘ prevailing under the teat 210a, 210b, 210c, 210d during at least a part of the milking session, independently of the amount of milk flow of each respective teat 210a, 210b, 210c, 210d.

In some embodiments, the vacuum pressure level P₂ₐ, P_{2b}, P_{2c}, P_{2d} as measured under the respective teat 210a, 210b, 210c, 210d may be achieved and maintained at a relatively constant milking vacuum pressure level Pₘ during the milking session. In order to achieve that, the inlet vacuum pressure level P₁ₐ, P_{1b}, P_{1c}, P_{1d} may be continuously adjusted, based on the repeated measurements of the vacuum pressure level P₂ₐ, P_{2b}, P_{2c}, P_{2d} under the teat 210a, 210b, 210c, 210d.

In other embodiments, the vacuum pressure level P₂ₐ, P_{2b}, P_{2c}, P_{2d} prevailing under the teat 210a, 210b, 210c, 210d may be temporarily increased to a high flow milking vacuum pressure level P_{HF} when an estimated difference between a highest measurement and a lowest measurement of the vacuum pressure level P₂ₐ, P_{2b}, P_{2c}, P_{2d} as measured by the respective vacuum pressure sensor 160a, 160b, 160c, 160d under one of the teats 210a, 210b, 210c, 210d during a time period. This time period may be predetermined or configurable; for example, 5-60 seconds, preferably 15-30 seconds. The measurements obtained during the latest for example 5-60 seconds may thus be compared and the maximum difference between the two extreme measurements (highest/lowest) during the time period estimated.

When the estimated difference is smaller than a threshold limit, the desired milking vacuum pressure level Pₘ may be set, temporarily, to the high flow milking vacuum pressure level P_{HF} for the teat cup 110a, 110b, 110c, 110d.

The threshold limit may be configurable or predetermined and be for example 1% of the milking vacuum pressure level Pₘ.

The desired milking vacuum pressure level Pₘ may for example be 44 kPa while the high flow milking vacuum pressure level P_{HF} may be for example 49 kPa (non-limiting examples).

The processing device 170 may continuously/repeatedly obtain measurements of the vacuum pressure level P₂ₐ, P_{2b}, P_{2c}, P_{2d} under the teat 210a, 210b, 210c, 210d with the respective associated vacuum pressure sensors 160a, 160b, 160c, 160d.

FIGS. 3A and 3B illustrate a simplified/functional overview of the milking system 100 according to two distinct embodiments, wherein details have been omitted, such as illustrating only one teat cup 110, not to obscure the provided solution.

The vacuum pump 140 may generate vacuum, i.e., under-pressure below atmospheric pressure, which is called system vacuum pressure Pₛ which is supplied to the milk tank 130. The system vacuum pressure Pₛ generated by the vacuum pump 140, prevailing in the milk tank 130 may be maintained substantially constant during the majority time of the milking session.

In FIG. 3A, vacuum adjustment arrangement 150 comprises an operable valve 310 having a passage which is adjustable by an electric control signal provided by the processing device 170. The operable valve 310 may be adjusted by an actuator 320, for example a solenoid or similar device. The valve 310 may be arranged in the milk evacuation tube 120, so that the milk extracted during the milk session passes the passage.

By adjusting the passage of the operable valve 310, an inlet vacuum pressure level P₁ is created, which is provided to the teat cup 110, possibly via the optional milk meter 250 arranged on the milk evacuation tube 120. The animal teat 210 when inserted in the teat cup 110 is exposed to a vacuum pressure level P₂ under the teat 210, which is measured by a vacuum pressure sensor 160 and repeatedly provided to the processing device 170.

The vacuum pressure sensor 160 may be arranged in a lower end of the teat cup 110, or at the section of the milk evacuation tube 120 in relative closeness of the teat cup 110, for example some centimetres, or one or some decimetres from the teat cup 110. The vacuum pressure sensor 160 may measure the vacuum pressure level P₂ prevailing in the teat cup 110 under one of the teats 210 when inserted into the teat cup 110.

The processing device 170 may then repeatedly compare the obtained vacuum pressure level P₂ under the teat 210 with a desired milking vacuum pressure level Pₘ and, based on the outcome of the comparison, generate a command to the actuator 320 to either open or close the passage of the operable valve 310, thereby increasing/decreasing the inlet vacuum pressure P₁, which in turn may change the vacuum pressure level P₂ under the teat 210.

The vacuum adjustment arrangement 150 in FIG. 3B comprises a vacuum regulator 153 and a valve device 155, for example as illustrated in FIGS. 1-2 and previously discussed in the corresponding section of the description. The valve device 155 may for example comprise a per se known shut off valve.

The vacuum pump 140 is connected to the vacuum adjustment arrangement 150, thereby providing system vacuum Pₛ to the vacuum adjustment arrangement 150. By regulating a milk passage of a shut off valve in a controlled manner, the vacuum adjustment arrangement 150 may adjust the inlet vacuum pressure level P₁ provided to the teat cup 110.

The vacuum regulator 153 of the vacuum adjustment arrangement 150 may comprise a solenoid wherein position of a valve of the solenoid may be adjusted by adjusting a magnetic field surrounding the solenoid which may be pulse width modulated for example with a Pulse Width Modulation (PWM) signal generated by a processing device 170 communicatively connected to the vacuum regulator 153, thereby changing a mixture of system vacuum Pₛ of the vacuum pump 140 and air of atmospheric pressure for generating a control vacuum P_{c}.

The vacuum regulator 153 may comprise or be connected to the valve device 155. The valve device 155 may be arranged in, or associated with, the milk evacuation tube 120 of the teat cup 110.

The valve device 155 may comprise a wet section and a dry section, separated by a membrane. The milk evacuation tube 120 may pass the wet section of the valve device 155.

The vacuum pressure level prevailing in the teat cup 110 of the milk evacuation tube 120, upstreams the valve device 155 may be adjusted to substantially the same vacuum level as a control vacuum level P_{c} provided to the dry section of the valve device 155 by the vacuum regulator 153.

Thus, the vacuum pressure level P₂ prevailing in the teat cup 110 under the teat 210 may be adjusted individually for each teat 210 of the animal 200 in order to achieve a target/desired vacuum pressure level Pₘ in the teat cup 110 under the teat 210.

The animal teat 210 when inserted in the teat cup 110 is exposed to a vacuum pressure level P₂ under the teat 210, which is measured by the vacuum pressure sensor 160 and repeatedly provided to the processing device 170.

The processing device 170 may then repeatedly obtain a measurement of the vacuum pressure level P₂ in the teat cup 110, compare the obtained measurement with a desired milking vacuum pressure level Pₘ. Based on the outcome of the comparison, the processing device 170 may calculate an adjustment of the inlet vacuum pressure level P₁ in order to adjust the vacuum pressure level P₂ under the teat 210 to the desired milking vacuum pressure level Pₘ. Then, the processing device 170 may generate a command to the vacuum regulator 153 of the vacuum adjustment arrangement 150, to adjust the control vacuum P_{c} provided to the valve device 155, which in turn adjusts the inlet vacuum pressure level P₁ provided to the teat cup 110, thereby adjusting the vacuum pressure level P₂ under the teat 210. This procedure may then be repeated during the milking session.

FIG. 4A illustrates milk flow and measurement of the vacuum pressure level P₂ₐ, P_{2b}, P_{2c}, P_{2d} prevailing in the associated teat cup 110a, 110b, 110c, 110d under one of the teats 210a, 210b, 210c, 210d from the vacuum pressure sensor 160a, 160b, 160c, 160d of a teat 210a, 210b, 210c, 210d of an animal 200 during a milking session 400, according to an embodiment.

The upper section of FIG. 4A illustrates the milk flow of a teat 210a, 210b, 210c, 210d in an example while the lower section illustrates the vacuum pressure level P₂ in the teat cup 110a, 110b, 110c, 110d.

The milk flow according to the milk curve may have very different shape/size, both for different teats and for different animals 200, the illustrated milk curve is merely an arbitrary example.

In some embodiments, the desired vacuum pressure level of the teat cup 110a, 110b, 110c, 110d may be set to a detachment vacuum pressure P_{d} in the teat cup 110a, 110b, 110c, 110d, which may be set to e.g., 10-20 kPa, such as for example about 15 kPa towards the end phase of the milking session 400. Thereby, a swift teat cup take-off is assured.

The end phase of the milking session 400 may be detected for example by measuring a time from attachment of the first (or possibly the last) teat cup 110a, 110b, 110c, 110d and compare it with a time limit tl.

FIG. 4B illustrates milk flow and measurement of the vacuum pressure level P₂ₐ, P_{2b}, P_{2c}, P_{2d} prevailing in the associated teat cup 110a, 110b, 110c, 110d under one of the teats 210a, 210b, 210c, 210d from the vacuum pressure sensor 160a, 160b, 160c, 160d of a teat 210a, 210b, 210c, 210d of an animal 200 during a milking session 400, according to an embodiment.

The upper section of FIG. 4B illustrates the milk flow of one teat 210a, 210b, 210c, 210d in an example while the lower section illustrates the vacuum pressure level P₂ in the corresponding teat cup 110a, 110b, 110c, 110d.

In some embodiments, the desired vacuum pressure level of the teat cup 110a, 110b, 110c, 110d may be set to a high flow milking vacuum pressure level P_{HF}. The high flow milking vacuum pressure level P_{HF} may be set to about e.g., 45-55 kPa, e.g., 49 kPa (non-limiting examples). The high flow milking vacuum pressure level P_{HF} represents more under-pressure than the milking vacuum pressure level Pₘ, which may be for example 44 kPa.

The high flow milking vacuum pressure level P_{HF} may be set as a desired target value for the vacuum pressure level of the teat cup 110a, 110b, 110c, 110d at least temporarily when an estimated difference between a highest measurement and a lowest measurement of the vacuum pressure level P₂ₐ, P_{2b}, P_{2c}, P_{2d} as measured by the vacuum pressure sensor 160a, 160b, 160c, 160d under one of the teats 210a, 210b, 210c, 210d during a time period is smaller than a threshold limit.

In other embodiments, the high flow milking vacuum pressure level P_{H}F may be set when a trigger time, tl1, has passed since first teat stimulation, or from commencement of the milking session 400.

In yet some embodiments, these two embodiments may be combined, i.e., the high flow milking vacuum pressure level P_{H}F may be set for example not before the trigger time tl1 has passed and the estimated vacuum pressure difference under the teat 210a, 210b, 210c, 210d during the time period is smaller than the threshold limit.

Correspondingly, the desired vacuum pressure level of the teat cup 110a, 110b, 110c, 110d may be reduced to the normal flow milking vacuum pressure level Pₘ after having been set to the high flow milking vacuum pressure level P_{H}F when the milk flow of the teat 210a, 210b, 210c, 210d is decreasing.

This may be made when the estimated difference between the highest measurement and the lowest measurement of the vacuum pressure level P₂ₐ, P_{2b}, P_{2c}, P_{2d} as measured by the vacuum pressure sensor 160a, 160b, 160c, 160d under the teat 210a, 210b, 210c, 210d during the time period exceeds the threshold limit. This may be interpreted as the milk flow of the animal/teat 210a, 210b, 210c, 210d is decreasing and the milk flow has passed the peak plateau of the milk flow.

In yet some embodiments, the vacuum pressure level P₂ₐ, P_{2b}, P_{2c}, P_{2d} of the teat cup 110a, 110b, 110c, 110d may be decreased to the normal milking vacuum pressure level Pₘ when a second trigger time, tl2, has passed since the setting of the desired vacuum pressure level to the high flow milking vacuum pressure level P_{HF}. In other embodiments, the second trigger time may be set from commencement of the milking session 400, for example since first teat stimulation.

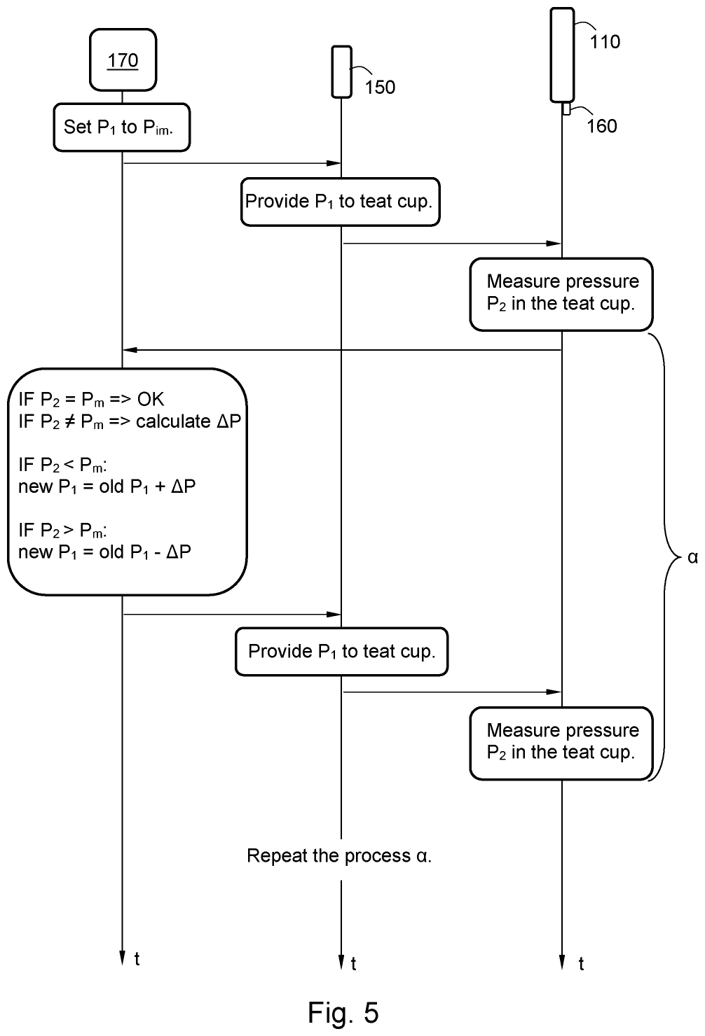

FIG. 5 schematically illustrates the adjustment process of the vacuum pressure level P₂ₐ, P_{2b}, P_{2c}, P_{2d} prevailing in each respective teat cup 110a, 110b, 110c, 110d under each respective teat 210a, 210b, 210c, 210d of the animal 200.

The processing device 170 may detect commencement of the milking session 400 of the animal 200 at attachment of the teat cups 110a, 110b, 110c, 110d to the teats 210a, 210b, 210c, 210d.

The processing device 170 may set an inlet vacuum pressure level P₁ₐ, P_{1b}, P_{1c}, P_{1d} of the vacuum adjustment arrangements 150a, 150b, 150c, 150d to an inlet milking vacuum pressure level Pᵢₘ. The inlet milking vacuum pressure level Pᵢₘ may be predetermined and retrieved from a memory device or database 180, 193. The inlet milking vacuum pressure level Pᵢₘ may for example be set to a value within the interval of 35-45 kPa, in some arbitrary examples.

In some other examples, the inlet milking vacuum pressure level Pᵢₘ may be set to an inlet attachment vacuum pressure level Pᵢₐ, which is lower than the vacuum pressure level applied during the milk extraction, for example set to 20-35 kPa, or there about.

The processing device 170 send an instruction to the vacuum adjustment arrangements 150a, 150b, 150c, 150d, to set the inlet vacuum pressure level P₁ₐ, P_{1b}, P_{1c}, P_{1d} to the inlet milking vacuum pressure level Pᵢₘ and provide that vacuum pressure to the teat cups 110a, 110b, 110c, 110d. The inlet milking vacuum pressure level Pᵢₘ may thus be common for being provided to all teat cups 110a, 110b, 110c, 110d.

A vacuum pressure sensor 160a, 160b, 160c, 160d at each of the teat cups 110a, 110b, 110c, 110d may then measure vacuum pressure level P₂ₐ, P_{2b}, P_{2c}, P_{2d} prevailing in each respective teat cup 110a, 110b, 110c, 110d under each respective teat 210a, 210b, 210c, 210d of the animal 200. These pressure measurements P₂ₐ, P_{2b}, P_{2c}, P_{2d} are then provided to the processing device 170. The respective pressure measurements P₂ₐ, P_{2b}, P_{2c}, P_{2d} of the respective teat cup 110a, 110b, 110c, 110d may be different, as milk flow rate of the respective teats 210a, 210b, 210c, 210d may be different.

The processing device 170 may extract a desired milking vacuum pressure level Pₘ from a memory device or database 180, 193, to be achieved and maintained in the teat cups 110a, 110b, 110c, 110d. A comparison between each of the pressure measurements P₂ₐ, P_{2b}, P_{2c}, P_{2d} and the desired milking vacuum pressure level Pₘ may then be made.

In case the measured pressure measurement P₂ₐ, P_{2b}, P_{2c}, P_{2d} in the teat cups 110a, 110b, 110c, 110d is equal to the desired milking vacuum pressure level Pₘ (or within a tolerance therefrom, for example within 1-5%), no change of the inlet vacuum pressure level P₁ₐ, P_{1b}, P_{1c}, P_{1d} provided to the teat cup 110a, 110b, 110c, 110d may be made.

Otherwise, i.e., when the pressure measurement P₂ₐ, P_{2b}, P_{2c}, P_{2d} deviates from the desired milking vacuum pressure level Pₘ (or outside the tolerance therefrom), a respective adjustment ΔP of the inlet vacuum pressure level P₁ₐ, P_{1b}, P_{1c}, P_{1d} may be calculated according to an algorithm, or extracted from a table in the memory/database 180, 193 in different embodiments. For example: in case one of the measured pressure measurements P₂ₐ, P_{2b}, P_{2c}, P_{2d} in the teat cup 110a, 110b, 110c, 110d exceeds the desired milking vacuum pressure level Pₘ with 10% (of the desired milking vacuum pressure level Pₘ), the inlet vacuum pressure level P₁ₐ, P_{1b}, P_{1c}, P_{1d} provided by the vacuum adjustment arrangement 150a, 150b, 150c, 150d to the relevant teat cup 110a, 110b, 110c, 110d may be decreased with 10%, in some embodiments (arbitrary, non-limiting example).

An instruction concerning a new respective inlet vacuum pressure level P₁ₐ, P_{1b}, P_{1c}, P_{1d} may thereby be calculated and provided to the vacuum adjustment arrangement 150a, 150b, 150c, 150d. The vacuum adjustment arrangement 150a, 150b, 150c, 150d, upon receiving the new, recalculated inlet vacuum pressure level P₁ₐ, P_{1b}, P_{1c}, P_{1d} may then adjust the inlet vacuum pressure and provide it to the respective teat cup 110a, 110b, 110c, 110d.

The vacuum pressure sensor 160a, 160b, 160c, 160d at each of the teat cups 110a, 110b, 110c, 110d may then measure the vacuum pressure level P₂ₐ, P_{2b}, P_{2c}, P_{2d} again, after having received the adjusted inlet vacuum pressure level P₁ₐ, P_{1b}, P_{1c}, P_{1d}, and report the latest pressure measurements P₂ₐ, P_{2b}, P_{2c}, P_{2d} to the processing device 170.

This process a of measuring vacuum pressure level P₂ₐ, P_{2b}, P_{2c}, P_{2d} in the teat cups 110a, 110b, 110c, 110d, compare the resulting pressure measurement P₂ₐ, P_{2b}, P_{2c}, P_{2d} with the desired milking vacuum pressure level Pₘ, recalculating the inlet vacuum pressure level P₁ₐ, P_{1b}, P_{1c}, P_{1d} and provide the adjusted inlet vacuum pressure level P₁ₐ, P_{1b}, P_{1c}, P_{1d} to the teat cups 110a, 110b, 110c, 110d may then be repeated until the end of the milking session 400.

Thanks to the provided solution, it is possible to dynamically adjust the vacuum pressure level P₂ₐ, P_{2b}, P_{2c}, P_{2d} in the teat cups 110a, 110b, 110c, 110d prevailing under each respective teat 210a, 210b, 210c, 210d of the animal 200. The inlet vacuum pressure level P₁ₐ, P_{1b}, P_{1c}, P_{1d} applied to each teat cup 110a, 110b, 110c, 110d is thereby consequently varying depending on the milk flow rate of the teat 210a, 210b, 210c, 210d in question.

Thereby the milking efficiency is improved, while eliminating or at least reducing teat damages due to excessive vacuum pressure, exceeding a maximum allowed vacuum pressure level. It is thereby estimated that teat condition of the animal 200 is increased. Also, more animals per time unit could be milked by the milking system 100 due to the shortened milking time per animal.

The terminology used in the description of the embodiments as illustrated in the accompanying drawings is not intended to be limiting of the described milking system 100; processing device 170 and/or computer program. Various changes, substitutions and/or alterations may be made, without departing from invention embodiments as defined by the appended claims.

The various illustrated embodiments depicted in FIGS. 1-5, and/or discussed in the corresponding respective section of the description may with advantage be combined with each other, for example by mixing and compiling features of some or all of the described embodiments, thereby achieving additional advantages.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g., a processor may fulfil the functions of several items recited in the claims. The mere fact that certain measures or features are recited in mutually different dependent claims, illustrated in different figures or discussed in conjunction with different embodiments does not indicate that a combination of these measures or features cannot be used to advantage.

1. A milking system (100), comprising:
a plurality of teat cups (110a, 110b, 110c, 110d), each teat cup configured to fit on a respective teat (210a, 210b, 210c, 210d) of an animal (200) during milk extraction in a milking session (400);
a plurality of milk evacuation tubes (120a, 120b, 120c, 120d), wherein each milk evacuation tube (120a, 120b, 120c, 120d) is connected to a respective teat cup (110a, 110b, 110c, 110d);
a vacuum pump (140); configured to generate a system vacuum pressure (Pₛ);
a milk tank (130), the milk tank (130) connected to each of the teat cups (110a, 110b, 110c, 110d) via the respective connected milk evacuation tube (120a, 120b, 120c, 120d), and also connected to the vacuum pump (140);
a plurality of vacuum adjustment arrangements (150a, 150b, 150c, 150d), each vacuum adjustment arrangement located along a respective one of the milk evacuation tubes (120a, 120b, 120c, 120d) and associated with a respective one of the teat cups (110a, 110b, 110c, 110d), and each vacuum adjustment arrangement (120a, 120b, 120c, 120d) being configured to adjust an inlet vacuum pressure level (P₁ₐ, P_{1b}, P_{1c}, P_{1d}) provided by the respective one of the milk evacuation tubes (120a, 120b, 120c, 120d) to the respective teat cup (110a, 110b, 110c, 110d);
a plurality of vacuum pressure sensors (160a, 160b, 160c, 160d), each vacuum pressure sensor associated with one of the teat cups (110a, 110b, 110c, 110d) and configured to measure a vacuum pressure level (P₂ₐ, P_{2b}, P_{2c}, P_{2d}) prevailing in the associated teat cup (110a, 110b, 110c, 110d) under one of the teats (210a, 210b, 210c, 210d) during the milking session (400);
a processing device (170) communicatively connected to the vacuum adjustment arrangements (150a, 150b, 150c, 150d), and the vacuum pressure sensors (160a, 160b, 160c, 160d), wherein the processing device (170) is configured to:
generate a respective command to each vacuum adjustment arrangement (150a, 150b, 150c, 150d), to set the inlet vacuum pressure level (P₁ₐ, P_{1b}, P_{1c}, P_{1d}) provided by the respective one of the milk evacuation tubes (120a, 120b, 120c, 120d) to an inlet milking vacuum pressure level (Pᵢₘ) and provide the inlet vacuum pressure level (P₁ₐ, P_{1b}, P_{1c}, P_{1d}) to the associated teat cup (110a, 110b, 110c, 110d);
obtain, repeatedly during the milking session (400), a measurement of the vacuum pressure level (P₂ₐ, P_{2b}, P_{2c}, P_{2d}) prevailing in the associated teat cup (110a, 110b, 110c, 110d) under one of the teats (210a, 210b, 210c, 210d) from the vacuum pressure sensor (160a, 160b, 160c, 160d) of the associated teat cup (110a, 110b, 110c, 110d);
compare, repeatedly during the milking session (400), the obtained respective measurement of the vacuum pressure level (P₂ₐ, P_{2b}, P_{2c}, P_{2d}) with a desired milking vacuum pressure level (Pₘ);
calculate, repeatedly during the milking session (400), an adjustment (ΔP) of the inlet vacuum pressure level (P₁ₐ, P_{1b}, P_{1c}, P_{1d}) to be provided by each respective vacuum adjustment arrangements (150a, 150b, 150c, 150d) to the associated teat cup (110a, 110b, 110c, 110d) in order to achieve the desired milking vacuum pressure level (Pₘ) in the associated teat cup (110a, 110b, 110c, 110d), based on the made comparison; and
generate, repeatedly during the milking session (400), a respective command to each vacuum adjustment arrangement (150a, 150b, 150c, 150d), to adjust the inlet vacuum pressure level (P₁ₐ, P_{1b}, P_{1c}, P_{1d}) according to the respectively calculated adjustment (ΔP), thereby achieving the desired milking vacuum pressure level (Pₘ) at each respective associated teat cup (110a, 110b, 110c, 110d), as measured by the respective vacuum pressure sensor (160a, 160b, 160c, 160d) under each of the teats (210a, 210b, 210c, 210d) of the milking session (400), independently of an identity of the animal (200).

2. The milking system (100) according to claim 1, wherein the processing device (170) is configured to:
generate, repeatedly during the milking session (400), the command to adjust the inlet vacuum pressure level (P₁ₐ, P_{1b}, P_{1c}, P_{1d}) in order to achieve the desired milking vacuum pressure level (Pₘ) substantially constant at each respective associated teat cup (110a, 110b, 110c, 110d), as measured by the respective vacuum pressure sensor (160a, 160b, 160c, 160d) under each of the teats (210a, 210b, 210c, 210d) during at least a majority time of the milking session (400).

3. The milking system (100) according to claim 1, wherein the processing device (170) is configured to:
estimate a difference between a highest measurement and a lowest measurement, respectively, of the vacuum pressure level (P₂ₐ, P_{2b}, P_{2c}, P_{2d}) in one of the teat cups (110a, 110b, 110c, 110d), as measured by the vacuum pressure sensor (160a, 160b, 160c, 160d) during a time period; and
in case the estimated difference is smaller than a threshold limit:
set, temporarily, the desired milking vacuum pressure level (Pₘ) to a high flow milking vacuum pressure level (P_{HF}) for the teat cup (110a, 110b, 110c, 110d).

4. The milking system (100) according to claim 1, wherein the processing device (170) is configured to repeatedly during the milking session (400):
generate a respective command to the vacuum adjustment arrangement (150a, 150b, 150c, 150d) associated with each teat cup (110a, 110b, 110c, 110d) attached to the respective teat (210a, 210b, 210c, 210d), to either
increase the inlet vacuum pressure level (P₁ₐ, P_{1b}, P_{1c}, P_{1d}) to be provided to the teat cup (110a, 110b, 110c, 110d) with the adjustment (ΔP) when the latest obtained vacuum pressure level (P₂ₐ, P_{2b}, P_{2c}, P_{2d}) under the teat (210a, 210b, 210c, 210d), obtained from the vacuum pressure sensor (160a, 160b, 160c, 160d) is lower than the desired milking vacuum pressure level (Pₘ) under the teat (210a, 210b, 210c, 210d); or
decrease the inlet vacuum pressure level (P₁ₐ, P_{1b}, P_{1c}, P_{1d}) to be provided to the teat cup (110a, 110b, 110c, 110d) with the adjustment (ΔP) when the latest obtained vacuum pressure level (P₂ₐ, P_{2b}, P_{2c}, P_{2d}) under the teat (210a, 210b, 210c, 210d), obtained from the vacuum pressure sensor (160a, 160b, 160c, 160d) exceeds the desired milking vacuum pressure level (Pₘ) under the teat (210a, 210b, 210c, 210d).

5. The milking system (100) according to claim 4, wherein the size of the adjustment (ΔP) is proportional to a difference between the latest obtained vacuum pressure level and the previously obtained vacuum pressure level, as measured by and obtained from the respective vacuum pressure sensor (160a, 160b, 160c, 160d).

6. The milking system (100) according to claim 1, wherein the processing device (170) is configured to:
generate a respective command to at least one vacuum adjustment arrangement (150a, 150b, 150c, 150d), to decrease the inlet vacuum pressure level (P₁ₐ, P_{1b}, P_{1c}, P_{1d}) provided by the respective one of the milk evacuation tubes (120a, 120b, 120c, 120d) at the corresponding teat cup (110a, 110b, 110c, 110d) when the milking session (400) is estimated to approach ending.

7. The milking system (100) according to claim 1, wherein the vacuum adjustment arrangements (150a, 150b, 150c, 150d) comprises a respective vacuum regulator (153a, 153b, 153c, 153d) and a valve device (155a, 155b, 155c, 155d) located in the respective one of the milk evacuation tubes (120a, 120b, 120c, 120d).

8. The milking system (100) according to claim 1,
wherein the vacuum adjustment arrangements (150a, 150b, 150c, 150d) comprises an operable valve (310) having a passage which is adjustable, and
wherein the valve (310) is arranged in the milk evacuation tube (120a, 120b, 120c, 120d) and the milk extracted during the milk session (400) passes the passage.

9. The milking system (100) according to claim 1, wherein the processing device (170) is configured to:
detect that the teat cups (110a, 110b, 110c, 110d) are to be attached on to the teats (210a, 210b, 210c, 210d) of the animal (200);
generate a respective command to each vacuum adjustment arrangement (150a, 150b, 150c, 150d), to set the inlet vacuum pressure level (P₁ₐ, P_{1b}, P_{1c}, P_{1d}) to an inlet attachment vacuum pressure level (Pᵢₐ) and provide the inlet vacuum pressure level (P₁ₐ, P_{1b}, P_{1c}, P_{1d}) to the associated teat cup (110a, 110b, 110c, 110d) in association with teat cup attachment, wherein the inlet attachment vacuum pressure level (Pᵢₐ) represents less under-pressure than the inlet milking vacuum pressure level (Pᵢₘ).

10. The milking system (100) according to claim 1, wherein a maximum allowed vacuum pressure level (Pₘₐₓ) allowed to prevail in any of the teat cups (110a, 110b, 110c, 110d) under any of the teats (210a, 210b, 210c, 210d), as measured by the vacuum pressure sensor (160a, 160b, 160c, 160d) is within an interval of 35-55 kPa.

11. The milking system (100) according to claim 1, wherein the vacuum pressure sensor (160a, 160b, 160c, 160d) is configured to measure the vacuum pressure level (P₂ₐ, P_{2b}, P_{2c}, P_{2d}) prevailing at each teat cup (110a, 110b, 110c, 110d) under the respective teat (210a, 210b, 210c, 210d) with substantially 10-1000 measurements per second.

12. The milking system (100) according to claim 1, wherein the processing device (170) is configured to:
calculate a rolling average of vacuum pressure levels (P₂ₐ, P_{2b}, P_{2c}, P_{2d}) prevailing at each teat cup (110a, 110b, 110c, 110d) under the respective teat (210a, 210b, 210c, 210d), based on a predetermined number of latest vacuum pressure levels (P₂ₐ, P_{2b}, P_{2c}, P_{2d}) obtained from the respectively associated vacuum pressure sensor (160a, 160b, 160c, 160d); and
wherein the comparison with the desired milking vacuum pressure level (Pₘ) is made with the calculated rolling average of vacuum pressure levels.

13. The milking system (100) according to claim 1, wherein the system vacuum pressure (Pₛ) generated by the vacuum pump (140), prevailing in the milk tank (130) is maintained substantially constant during the majority time of the milking session (400).

14. The milking system (100) according to claim 1, wherein the vacuum pressure sensor (160a, 160b, 160c, 160d) is configured to measure the vacuum pressure level (P₂ₐ, P_{2b}, P_{2c}, P_{2d}) prevailing at each teat cup (110a, 110b, 110c, 110d) under the respective teat (210a, 210b, 210c, 210d) with 100-1000 measurements per second.
